(19) United States
(12) Patent Application Publication
(10) Pub. No.: US 2018/0130073 A1
(43) Pub. Date: May 10, 2018

(54) METHOD AND SYSTEM FOR RECOMMENDING ASSETS ON RECENTLY VIEWED ASSETS BASKET

(71) Applicant: CBS INTERACTIVE INC., San Francisco, CA (US)

(72) Inventors: Cristen Carvis, Denver, CO (US); Clifford Lyon, Melrose, MA (US)

(73) Assignee: CBS INTERACTIVE INC., San Francisco, US (US)

(21) Appl. No.: 15/864,034

(22) Filed: Jan. 8, 2018

Related U.S. Application Data
(63) Continuation of application No. 12/982,403, filed on Dec. 30, 2010, now abandoned.
(60) Provisional application No. 61/312,172, filed on Mar. 9, 2010.

(51) Int. Cl. G06Q 30/02; G06Q 30/06; G06Q 10/10

(52) U.S. Cl. CPC G06Q 30/02; G06Q 30/0631; G06Q 30/0224; G06Q 10/10

(57) ABSTRACT

Methods, systems, and computer-readable media for recommending assets for a user include receiving the user's recently viewed assets list for a web domain that includes a plurality of assets; calculating a score for each asset in the web domain having an overlap of user interest based on mutual information; generating a set of neighbors for each item in the recently viewed assets list using the score; calculating a strength for each set of neighbors using the sum of the score for each neighbor in the set; generating an asset recommendation using the neighbor set with the highest score; and transmitting the asset recommendation.

### PRIORITY CLAIM

This application claims the benefit of U.S. Provisional Application Nos. 61/291,226, filed Dec. 30, 2009, and 61/312,172, filed Mar. 9, 2010; the disclosures of which are incorporated herein by reference in their entirety.

### BACKGROUND

The internet allows users to research products by locating product “landing pages” which often include descriptions, reviews, specifications, and prices of a product. A user searching for a product often has an interest in purchasing the specific product for which they search or another product with similar attributes and specifications. Commonly, online merchants provide a user with recommendations for additional products or alternatives that the merchant believes may interest the user.

These recommendations provide the user with suggestions that are identified based on a relationship between products the user has viewed or purchased and products that were viewed or purchased by other users. This type of relationship is often determined using a collaborative filter. Essentially, collaborative filters recommend products based on users' behaviors related to past page views or purchases. For example, it is known to make product recommendations based on items most frequently purchased together, as seen at WWW.AMAZON.COM™. However, this type of recommendation is reactive in nature.

Another major drawback to using collaborative filters for recommending products is that they are slow to account for new products that have recently entered the market. This issue is known as the “cold-start” problem. The consumer-product world is ever-evolving, and new products just reaching the market will often be more relevant to a user searching the web than the products viewed or purchased by others in the past, which are the products a collaborative filter would likely recommend. Collaborative filters are often unable to predict which recommendations will be most beneficial to a user searching the internet.

### BRIEF DESCRIPTION OF THE DRAWINGS

FIG. 1 is a functional block diagram of a computer architecture of an embodiment.

FIG. 2 is a structural block diagram of a computer architecture of an embodiment.

FIG. 3 is a schematic representation of a method of an embodiment used in providing the user with product recommendations.

FIG. 4 is an illustration of a product landing page.

FIG. 5 is an example of a viewer delivered to a user including a recommendation of assets.

FIG. 6 is a flowchart of an embodiment for recommending assets to a user.

FIG. 7 is a diagrammatic representation of a machine of an embodiment in the exemplary form of a computing device.

### DETAILED DESCRIPTION

The present embodiments heuristically address interest in a set of assets by evaluating the assets in turn and determining a “guide” asset for recommendation. The guide asset is the asset that produces the best possible recommendation(s) at any given time. By considering each asset in a set of recently viewed assets, the system maintains higher coverage than conventional methods that make recommendations based on a currently viewed asset (i.e., a singleton set). The present embodiment provides better coverage than systems that select a single item from the basket using criteria such as “most recent” or a reactive recommendation.

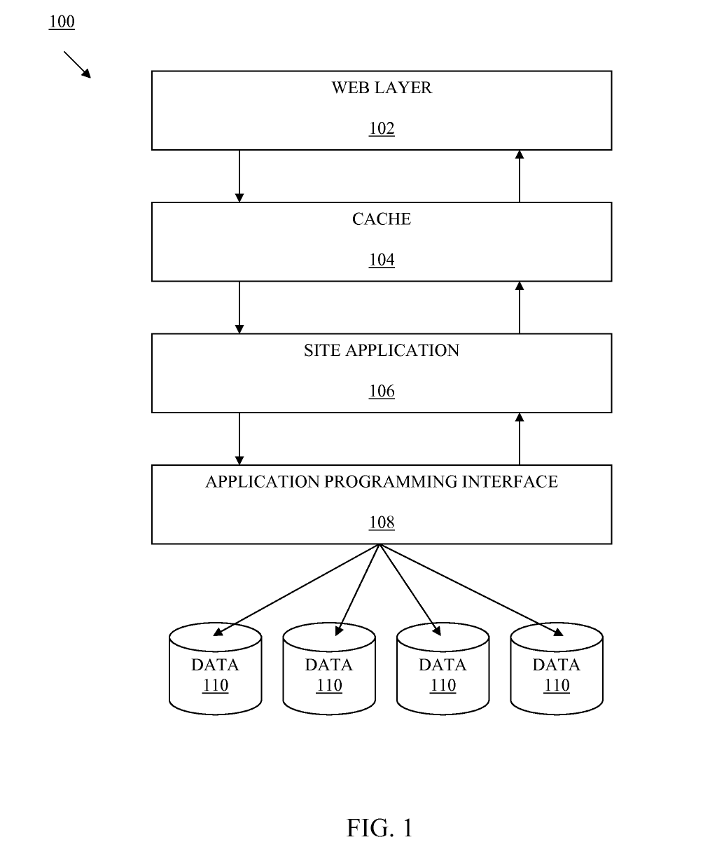

FIG. 1 depicts a functional illustration of a computer architecture. System architecture 100 includes a web layer 102, a cache 104, a site application 106, an application programming interface (“API”) 108, and plural data stores 110. However, the system architecture may vary from the illustrated architecture. For example, web layer 102 may directly access data stores 110, the site application 106 may directly access data stores 110, system architecture 100 may not include cache 104, etc. Web layer 102 may be configured to receive user requests to access content through a web browser and return content that is responsive to the user request. Web layer 102 may communicate the user requests to cache 104. Cache 104 may temporarily store content that is accessed frequently by web layer 102 and can be rapidly accessed by web layer 102. Cache 104 may be a caching proxy server and may communicate user requests to site application 106.

Site application 106 may be configured to update cache 104 and to process user requests received from web layer 102. Site application 106 may identify that the user request is for a page that includes data from multiple sources. Site application 106 may then convert the page request into a request for content from multiple sources and transmit these requests to API 108. API 108 may simultaneously access data from the plurality of data stores 110 to collect the data responsive to the plurality of requests from site application 106. The plurality of data stores 110 may include, for example, catalogue data about different asset types (e.g., products, news, digital content such as downloadable or streamable video, etc.) or asset metadata (e.g., product specifications, pricing, images, etc.), content components, and the like. Alternatively, only one data store 110 may be provided to store the data. Further, API 108 may be separate from the rest of architecture 100 and architecture 100 may communicate with API 108 over a network, for example the internet.

The data in data stores 110 may be provided to API 108, which may provide the content to site application 106. Site application 106 may update cache 104 and deliver cached content in combination with the accessed content to web layer 110, which may deliver browsable content to the user, such as through a product landing page.

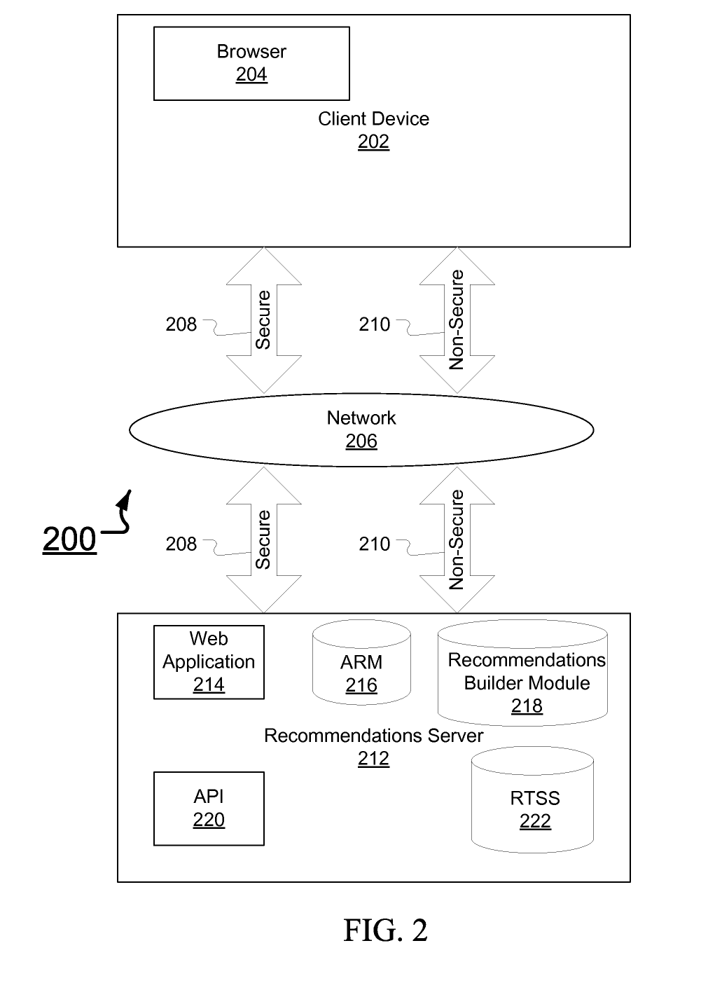

FIG. 2 shows a structural illustration of a computer architecture. Customizable uniform resource locator (“URL”) system 200 may include a client computer 202 configured to execute a browser application 204 that supports Hypertext Transfer Protocol (“HTTP”) or other appropriate protocols. Client computer 202 may be connected, typically through an Internet Service Provider (“ISP”), to network 206 serving as a communication channel. For example, client computer 202 may be coupled to the ISP through a broadband connection such as an Integrated Services Digital Network (“ISDN”) connection, a cable modem, or a Digital Subscriber Line (“DSL”) connection. Network 206 may be the internet, a wide area network (“WAN”), a local area network (“LAN”), or any other medium capable of allowing communication between computing devices. Recommendation server 212 may execute, for example, a web application 214, known as an HTTP server application, stored in a memory device. For example, public domain web server software applications from NCSA or APACHE can be used.

Both of the client computer 202 and the recommendations server 212 may be capable of communicating using a secure connection protocol, such as SSL or S-HTTP. For clarity, non-secure connections 210 and secure connections 208 are illustrated separately. However, these connections may be effected over the same physical connection or communication channel, such as the internet. Further, recommendations server 212 may have many product or other asset landing pages stored in memory devices thereof, such as in HTML format and/or other formats.

Client computer 202 can request a display of an asset page from recommendation server 212 by issuing a URL request through the internet to product server 212. For example, a user of client computer 202 (i.e., a user searching for an asset) can enter an asset query, including at least one asset term(s) and/or attribute(s), into a form page displayed by browser 204 or click a link for an asset. Assets may include, among other things, at least one of a product, a blog post, a user comment, a review, an article, a whitepaper, a news article, digital content (e.g., downloadable or stream able content such as streaming video, streaming audio, downloadable video, downloadable audio, and the like), a service, and a company. The browser interface may be populated with suggested asset landing pages that are based on the asset search criteria. The user may be able to select an asset landing page to be viewed, and each time the user visits an asset landing page, the asset ID, along with the user's session ID, may be saved to a Real Time Session Server (“RTSS”) 222. The RTSS 222 may be one or more computing devices configured to store user activity in real-time and enable the real-time retrieval of stored user activity data using an API.

Recommendation server 212 may execute, for example, an API 220 that requests asset landing pages once the web application 214 has received a request for an asset landing page. Recommendations server 212 may also include an asset relationship module 216 (“ARM”) stored in a storage device. ARM 216 provides content-optimization and recommendation, and may store recommendation data, such as data correlating user interest in products (e.g., users who viewed asset “A” also viewed asset “B”). When a user views the asset landing page for asset A, the system may present the user with a selection of at least one other asset (e.g., asset B) that was viewed by a different user that also viewed asset A. The recommended products may be presented to the user in a variety of ways, for example via a pop-up, a drop down list of products, a listing of rows, and/or columns of products, among other ways.

Each time a user visits an asset landing page, the asset ID, and the user's session ID, may be saved to the RTSS 222 and recently viewed assets may be displayed on the asset landing page, as further described below. Meanwhile, the recommendations builder module 218 may search for and locate the user's session ID, for example by extracting it from one or more cookies stored on the client device 202 or from the client device 202 connection to the recommendation server 212. The recommendations builder module 218 may be implemented via JavaScript, embedded in java code, or in implemented in alternative ways. The recommendations builder module 218 may use the user's session ID to retrieve a set of asset IDs corresponding to the user's recently viewed assets from the RTSS 222. The set of asset IDs may include plural asset IDs corresponding to plural products the user recently viewed. In some embodiments, the set of asset IDs may include a currently viewed asset, thus ensuring the set of asset IDs is not a null set. Embodiments may also include asset IDs of all assets previously viewed by a user in the set of asset IDs. The recommendations builder module 218 then may take the set of asset IDs and make a call to the ARM 216. One call from the recommendations builder module 218 may be a “recommendations for you” call to the ARM 216, which passes along the set of asset IDs corresponding to the user's recently viewed assets.

ARM 216 may use a recommendation algorithm to determine a set of “nearest neighbors” to each asset ID in the set of asset IDs (i.e., a set of assets having overlapping user interest). ARM 216 may then intelligently merge the results to form a set of nearest neighbors nearest the guide asset. Alternatively, ARM 216 may be configured to discount any repeat asset IDs in the set, to ensure that the set is disjoint, and determine a set of nearest neighbors to each asset ID remaining in the disjoint set. ARM 216 may then calculate a similarity measure based on asset co-occurrence among user sessions. For example, for all assets in either set, ARM 216 may calculate a score based on mutual information between each asset corresponding to an asset ID and all other assets in a catalog. For example, the score can be determined using the equation:

$$U ( X , Y ) = 2 \frac{I ( X , Y )}{H ( X ) + H ( Y )} \qquad ( 1 )$$

where I(X,Y) is mutual information, H(X) and H(Y) are the entropy of X and Y, U(X,Y) is the score, and the metric is “normalized mutual information”.

Alternatively, metrics using asset co-occurrence among user sessions other than mutual information may be used, for example support-confidence, improvement, leverage, conviction, and others. Further, nearest neighbors may be determined by metrics other than those using asset co-occurrence, for example through user-based collaborative filtering.

ARM 216 then calculates the “strength” of each neighbor set as the sum of the score for each neighbor. The neighbor set with the highest score may then be used for recommendation (i.e., the neighbor set of the guide asset).

For example, in a search for asset A, ARM 216 might recommend assets J, K, L, M, N, and O based on a single asset relationship analysis. For a prior search for asset B, ARM 216 might recommend assets P, Q, L, R, and S based on a single asset relationship analysis. Further, in a prior search for asset C, ARM 216 might recommend assets S, T, L, M, and U based on a single asset relationship analysis. However, ARM 216 may attempt to find a guide asset by generating a similarity score for each of a plurality of subsets of the set of recently viewed assets. Subsets may be singleton sets of previously viewed assets or combinations of previously viewed assets. For example, subsets may be (A), (B), (C), (A,B), (A,C), (B,C), and (A,B,C). ARM 216 may then calculate a strength for each subset by summing the set of similarity scores for that subset. In the case that ARM 216 calculates that subset (A) (i.e., a singleton set containing only recently viewed asset A) has the highest (i.e., greatest) strength, ARM 216 may generate an asset recommendation set including assets J, K, L, M, N, and O. Alternatively, in the case that ARM 216 calculates that subset (A,B,C) has the highest strength, ARM 216 may generate a mixed recommendation set, for example including L, M, S, J, and K, where L, M, and S might share specifications or attributes that the user is most interested in. The recommendations builder module 218 may then request that the API 220 obtain and return asset data for each of the asset IDs returned by the ARM 216. The recommendations builder module 218 may then build and transmit for displays to the user a viewer including a list of recommended assets based on the scores provided using the algorithm.

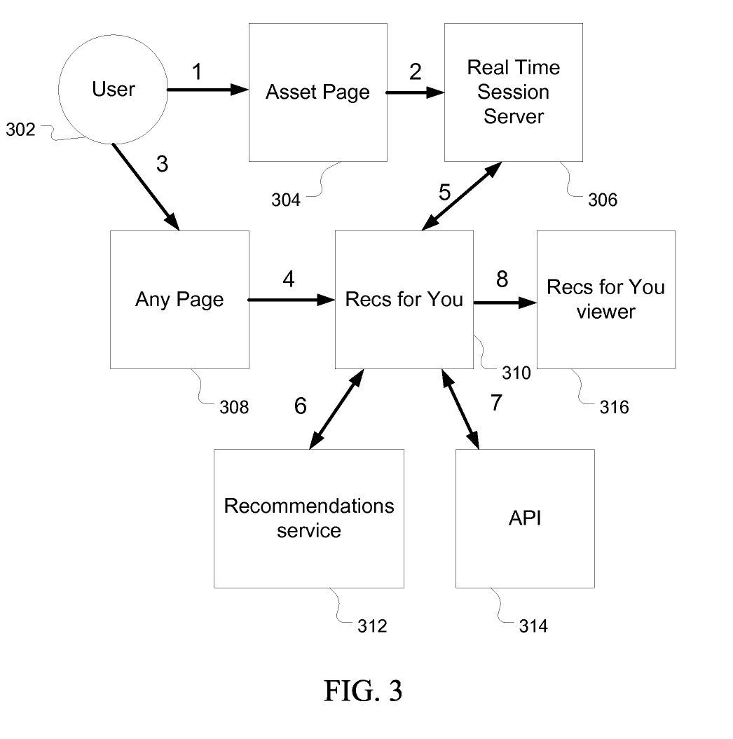

FIG. 3 schematically depicts a method of an embodiment. At step 1, a user 302 views an asset landing page 304 (i.e., a webpage displaying an asset and information about the asset, such as a webpage for purchasing a product or for streaming a video) for an asset A on a display device coupled to a computing device. At step 2, a computing device saves an identification of the asset and the user's session ID to a data store in RTSS 306. Steps 1 and 2 may be repeated every time a user navigates to or searches for another asset so that RTSS 306 may maintain a complete record of asset IDs and user session IDs for a user. Additionally, RTSS 306 may keep only a single record for each individual asset ID. Thus, when a user views the same asset for a second time, RTSS 306 may only update the user session ID to indicate that the user viewed the asset more recently or RTSS 306 may simply omit recording any data relating to a second view of an asset. Alternatively, RTSS 306 may save an identification of the asset and the user's session ID to a data store in RTSS 306 each time a user views an asset.

Step 3 may occur when a user 302 navigates to any page 308 configured to provide one or more “recommendations for you”. At step 3, the user's page request, as well as information identifying the user (e.g., IP address, user login information, cookies, etc.), are transmitted to a computing device for serving the page 308. The computing device serving the page 308 transmits all of this information to a recommendations for you module 310. The recommendations for you module 310 extracts the user's session ID from the user's page request and identifying information and, at step 5, transmits the user's session ID to RTSS 306. In response, RTSS 306 may query one or more data stores to retrieve the user's recently viewed assets and return a set of the assets to recommendations for you module 310. RTSS 306 may be configured to provide a set of all assets previously viewed, a predetermined number of assets previously viewed (e.g., the most recent fifty or less assets), a number of assets previously viewed as determined by the recommendations for you module 310 (e.g., the recommendations for you module 310 may transmit a request to RTSS 306 and specify that the request is for a set of the ten most recently viewed assets), etc. Additionally, the set of assets from RTSS 306 may or may not include duplicate assets.

At step 6, recommendations for you module 310 may transmit a request for to a recommendations service 312 for a custom “recommendations for you” recommendation. In making such a request, recommendations for you module 310 transmits to recommendations service 312 both the asset ID of the page 308 the user 302 is currently requesting and the set of viewed assets from RTSS 306. Recommendations service 312 then performs multiple single asset ID analyses to arrive at a recommendation asset set for both the asset on page 308 and for each of the assets in the set of viewed assets. Recommendations service 312 then intelligently merges the recommendation asset sets to arrive at a “recommendations for you” asset set, for example a set of plural assets. Recommendations service 312 may then return the “recommendations for you” asset set to recommendations for you module 310.

Additionally, at step 6, recommendations for you module 310 may transmit a request to recommendations service 312 for both a custom “recommendations for you” recommendation and a conventional similar products recommendation (or any other type of recommendation). In addition to the above recited steps for determining a custom recommendation, recommendations service 312 may perform a collaborative filtering function, or other data mining function, to determine a set of recommended assets. Recommendations service 312 may then return the recommended asset set to recommendations for you module 310 in addition to the “recommendations for you” asset set.

Further, recommendations for you module 310 may parse the recommended asset set and the “recommendations for you” asset set to determine and remove assets common to the two sets. For example, if the recommendations for you assets set includes assets A, B, C, D, and E and the recommended assets set includes assets D, E, F, G, and H, the recommendations for you module 310 may remove D and E from the recommended assets set and request two additional assets from recommendations service 312. Of course, recommendations for you module 310 may alternatively remove common assets from the “recommendations for you” asset set or may include logic to determine which asset set to remove duplicate assets from.

At step 7, the recommendations for you module 310 may request asset data for each of the assets in the “recommendations for you” asset set (and the recommended asset set if also received) from API 314. In response, API 314 may return the requested asset data. Of course, while API 314 provides a convenient interface for recommendations for you module 310 to retrieve asset data, alternative embodiments may include a data store accessible by an interface other than an API for recommendations for you module 310 to retrieve asset data.

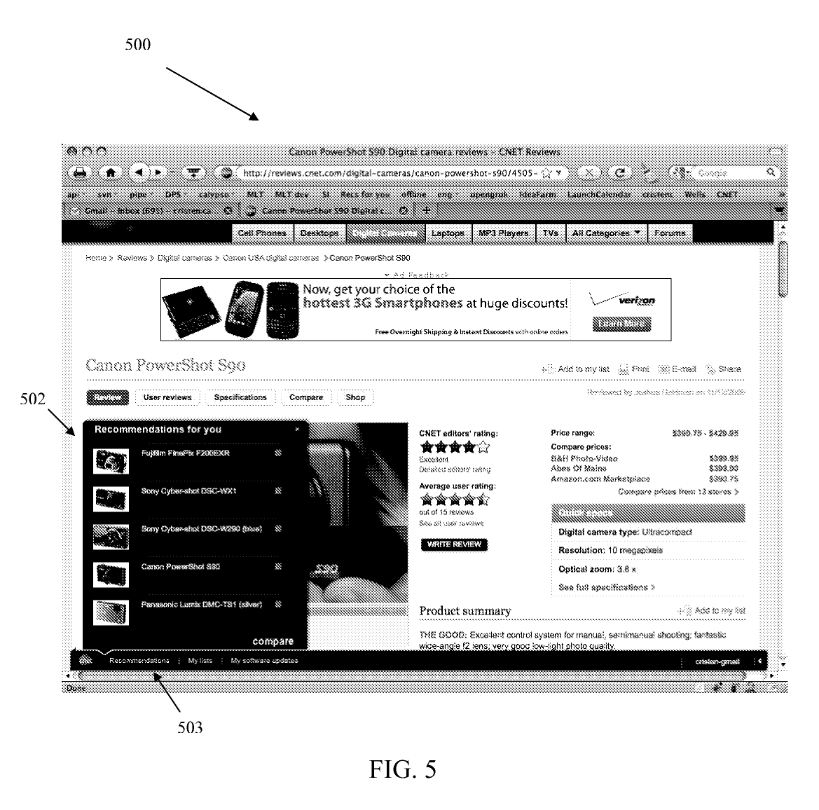

At step 8, recommendations for you module 310 transmits a “recommendations for you” asset set as well as asset data corresponding to each asset in the set to recommendations for you viewer 316. Viewer 316 may be a user interface (“UI”) displayed on a display device to a user 302 to show the user the recommendations for you asset set and data about each asset. For example, viewer 316 may be a viewer such as viewer 500 shown in FIG. 5 as discussed below. Alternatively, viewer 316 may be any other unit integrated in a webpage, may be a JavaScript bookmarklet, or may be any other user interface feature.

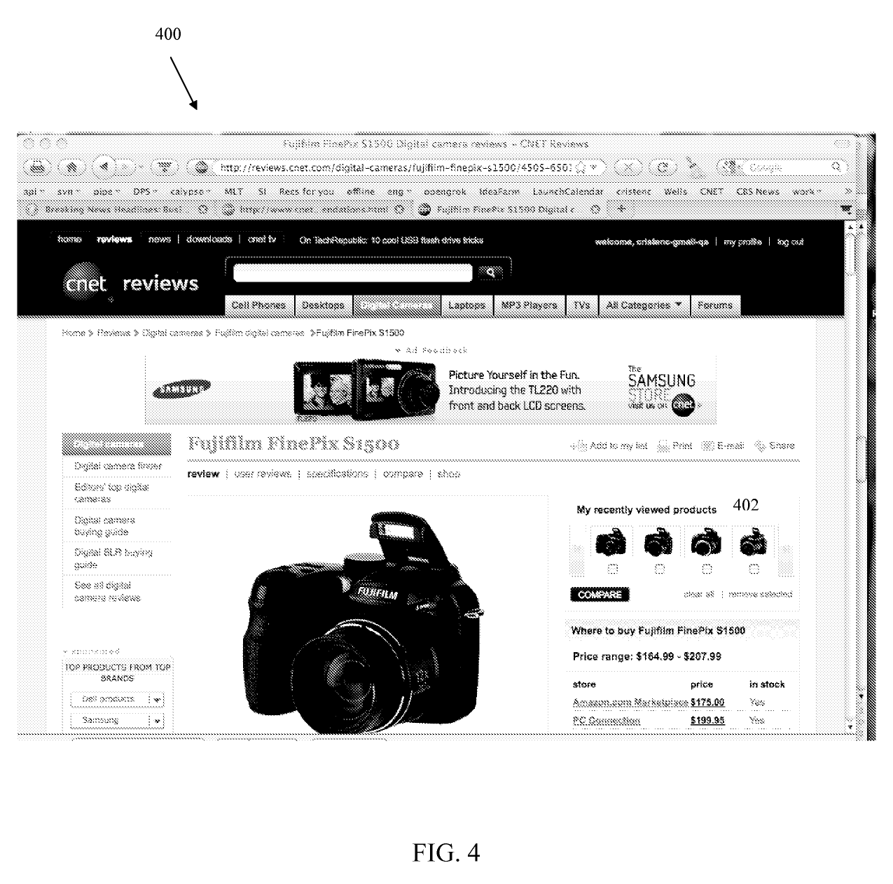

As seen in FIG. 4, each time a user visits an asset landing page 400, the current asset ID and the user's session ID may be saved to the RTSS (e.g., RTSS 222 shown in FIG. 2). The recently viewed assets may then be retrieved from the RTSS and displayed on the asset landing page 400, for example in “recently viewed products” UI display 402. Of course, recently viewed products and recommendations for you may be displayed on a webpage in a variety of ways to provide a convenient UI to a user.

FIG. 5 depicts one example of a viewer 500 that is built and transmitted to a user's display device to provide a “recommendations for you” UI display 502 in a web browser. “Recommendations for you” UI display 502 may be an expanded view of the recommendations for you presented after a user may click on a “Recommendations” link 503. The “Recommendations for you” UI display 502 can be assets recommended based on the scores provided using the algorithm using equation (1). Asset specifications may include an asset's price, type, dimensions, weight, material, color, display type, sound output, accessories, operating system, and manufacturer, among other things.

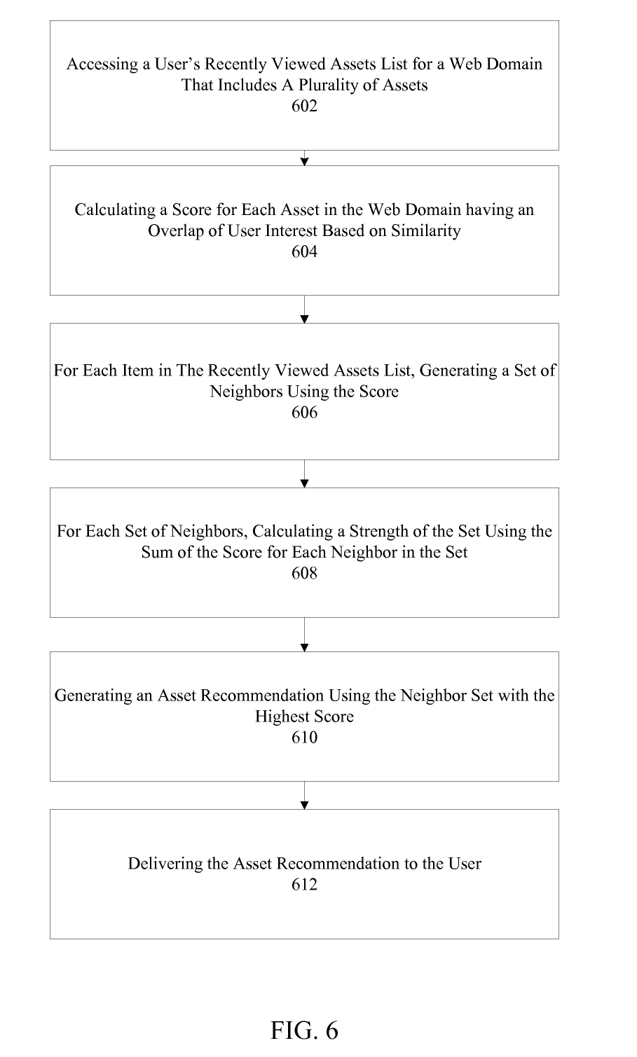

FIG. 6 is a flowchart of an embodiment for recommending assets to a user. In step 602, a computing device accesses a user's recently viewed asset list for a web domain that includes a plurality of assets. For example, a computing device may receive a user's recently viewed asset list from an operatively coupled computing device, for example over a network. Next, in step 604, a computing device calculates a score for each asset or subset of assets and possible related assets in the web domain having an overlap of user interest based on any one or more of several metrics described above. In step 606, a computing device generates similarity values (i.e., a score) for related items for each item in the recently viewed assets list. In step 608, for each item in the recently viewed assets list a computing device generates a set of neighbors using the score. Next, in step 610, a computing device generates one or more asset recommendations using the neighbor set with the highest score. In step 612, a computing device delivers the asset recommendations to the user. Delivery may be, for example, by transmitting the asset recommendation to a user's computing device for display to a user, for example over a network. Alternatively, the order of the steps of FIG. 6 may be altered. For example, in step 604 a computing device may pre-calculate a score for each asset or subset of assets and possible related assets in a web domain before step 602. Further, step 604 may be implemented as a batch process scheduled to occur periodically, for example daily.

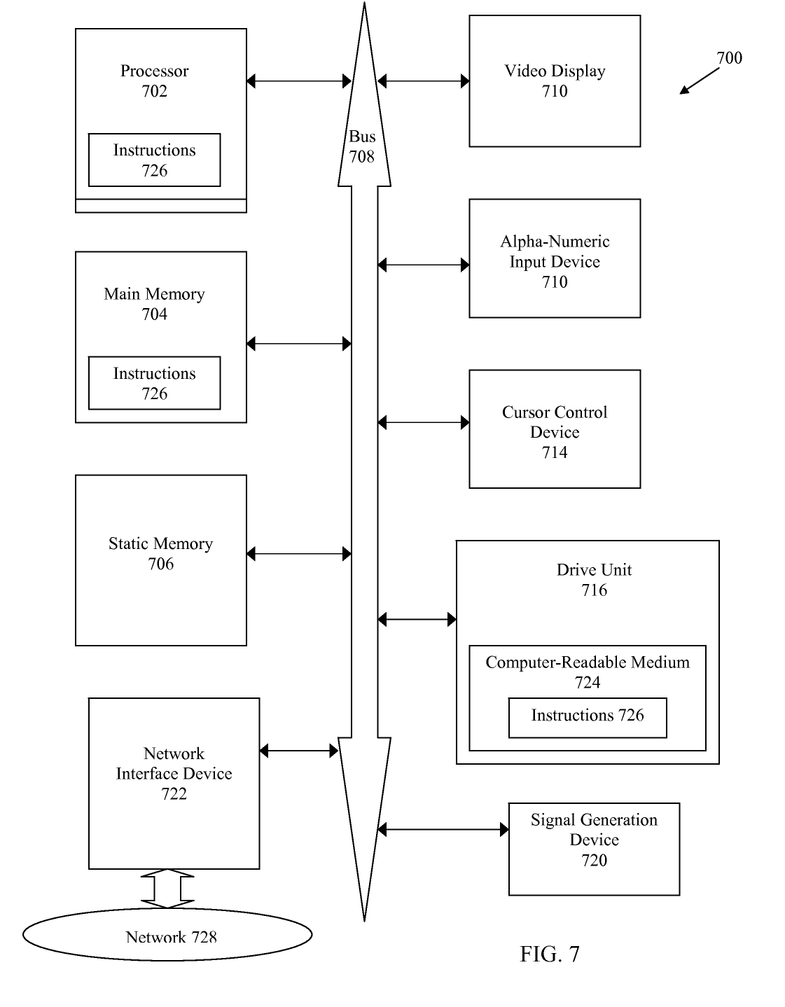

FIG. 7 depicts a diagrammatic representation of a machine in the exemplary form of a computing device 700 within which a set of instructions, for causing the computing device to perform any one or more of the methodologies discussed herein, may be stored on non-transitory memory and executed. The computing device may operate as a standalone computing device or may be connected (e.g., networked) to other computing devices. If in a network environment, the computing device may operate in the capacity of a server or a client computing device in server-client network environment, or as a peer computing devices in a peer-to-peer (or distributed) network environment. An exemplary computing device includes a personal computer (“PC”), a tablet PC, a set-top box (“STB”), a Personal Digital Assistant (“PDA”), a mobile phone (e.g., a smartphone), a web appliance, a network router, switch or bridge, or any machine capable of executing a set of instructions (sequential or otherwise) that specify actions to be taken by that machine. Further, while only a single computing device is illustrated in FIG. 7, the term “computing device” also includes any collection of computing devices that individually or jointly execute a set (or multiple sets) of instructions to perform any one or more of the methodologies discussed herein.

The exemplary computing device 700 includes a processor 702, e.g., a central processing unit (“CPU”), a graphics processing unit (“GPU”) or both, a main memory 704, which may include read only memory (“ROM”), flash memory, dynamic random access memory (“DRAM”) such as synchronous DRAM (“SDRAM”) or Rambus DRAM (“RDRAM”), etc., and a static memory 706. The static memory can include a flash memory, static random access memory (“SRAM”), etc., which communicate with each other via a bus 708. The memory may be non-transitory.

The computing device 700 may further include a video display unit 710, such as a liquid crystal display (“LCD”), plasma display device, a field emission device, an electroluminescent device, or a cathode ray tube (“CRT”), just to name a few. The computing device 700 may also include an alphanumeric input device 712, such as a keyboard, a cursor control device 714 (e.g., a mouse), a disk drive unit 716, a signal generation device 720, which may include a speaker, and a network interface device 722.

The disk drive unit 716 may include a computer-readable medium 724 on which one or more sets of instructions, such as software 726, may be stored embodying any one or more of the methodologies or functions described herein. The software 726 may also reside, completely or at least partially, within the main memory 704 and/or within the processor 702 during execution thereof by the computing device 700, the main memory 704 and the processor 702 also constituting computer-readable media. The software 726 may further be transmitted or received over a network 728 via the network interface device 722.

While the computer-readable medium 724 is shown as a single medium, the term “computer-readable medium” should be taken to include a single medium or multiple media (e.g., a centralized or distributed database, and/or associated caches and servers) that store the one or more sets of instructions. The term “computer-readable medium” shall also be taken to include any tangible and non-transitory medium that is capable of storing, encoding or carrying a set of instructions for execution by the machine and that cause the machine to perform any one or more of the methodologies. The term “computer-readable storage medium” shall accordingly be taken to include, but not be limited to, solid-state memories, and optical and magnetic media.

Thus, the above described method and apparatus provides an effective method for recommending relevant assets to a user.

Embodiments be implemented over any type of communications channel, such as the internet, a local area network (“LAN”), a wide area network (“WAN”), direct computer connections, or the like, using any type of communication hardware and protocols. Any type of hardware or combination of hardware can be used for various clients and servers. Accordingly, the terms “computer”, “computing device”, “computer system” and the like, as used herein, refer to any type of computing device or data terminal, such as a personal computer, a portable computer, a dumb terminal, a thin client, a hand held device or any combination of such devices. The various clients and servers can be a single computer at a single location or multiple computers at a single or multiple locations. For example, a server may be comprised of a plurality of redundant computers disposed in co-location facilities at various locations to facilitate scalability. Any appropriate server or client software can be used and any communication protocols can be used. Communication can be accomplished over electric cable, fiber optic cable, any other cable, or in a wireless manner using radio frequency, infrared, or other technologies. Any interface can be used for selecting assets for purchase. The various information can be stored in any format and thus the term “database” as used herein refers to any collection of information such as a database file, a lookup table, or the like.

While the content items may be catalog items, embodiments may be applied to any type of content organized in a hierarchy. For example, embodiments can be applied to various content items in a content management system such as audio content, video content, or textual content.

Additionally, asset recommendations and asset recommendation sets described herein may be transmitted to a client for display in any of a variety of ways, for example as part of a home page, a door, a blog, a product page, a product listings page, a news article, an asset landing page, a search results page, a profile page (e.g., a profile page within the web domain or within an installed software client such as tracking software), and an email.

The various functions can be implemented by modules which may be computer hardware programmed in a desired manner through instructions stored on non-transitory computer readable media.

Moreover, other embodiments will be apparent to those skilled in the art from consideration of the specification and practice of the embodiments disclosed herein. Various aspects and/or components of the described embodiments may be used singly or in any combination. It is intended that the specification and examples be considered as exemplary only.

1-20. (canceled)

21. A method providing recommendations to a user by one or more recommending computing devices based on user activity in a distributed network environment, the method comprising:
receiving multiple sets of user page view information from multiple distributed computing devices connected to the distributed network environment, each set of page view information including an identification of the user viewing a page and an identification of the page viewed by the user;
storing sets of user page information for each user in association with that user;
in response to a request from a user device for information from a distributed computing device, the information relating to an asset, determining, by at least one of the one or more recommending computing devices, a set of recently viewed assets based on one of the sets of user page information corresponding to the user
determining, by at least on of the one or more recommending computing devices, a set of neighbor assets associated with the recently viewed assets, wherein each neighbor asset is an asset which is associated with a corresponding recently viewed asset;
generating, by at least one of the one or more recommending computing devices, a plurality of subsets from the set recently viewed assets, wherein each subset in the plurality of subsets includes a plurality of recently viewed assets and has a corresponding neighbor subset comprising a plurality of neighbor assets associated with the plurality of recently viewed assets in the subset;
determining, by at least one of the one or more recommending computing devices, a score for each subset in the plurality of subsets to generate a plurality of scores, wherein the score for each subset is based on a strength of the association between the plurality of recently viewed assets in that subset and the plurality of neighbor assets in the corresponding neighbor subset;
determining, by at least one of the one or more recommending computing devices, the subset with the highest score;
generating, by at least one of the one or more recommending computing devices, one or more asset recommendations from the plurality of neighbor assets in the corresponding neighbor subset of the subset with the highest score; and
transmitting, by at least one of the one or more recommending computing devices, the one or more asset recommendations to the user device.

22. The method of claim 21, wherein generating a plurality of subsets includes excluding duplicate recently viewed assets in each subset.

23. The method of claim 21, wherein determining a score for each subset comprises:
calculating a similarity measure between each recently viewed asset in the subset and each of the plurality of neighbor assets in the neighbor subset associated with that subset to generate one or more similarity scores; and
summing the one or more similarity scores to generate the score for the subset.

24. The method of claim 23, wherein the similarity measure comprises at least one of symmetric uncertainty and co-occurrence of the recently viewed asset with the neighbor asset among user sessions.

25. The method of claim 21, wherein the plurality of recently viewed assets comprise at least one of a product, a blog post, a user comment, a review, an article, a whitepaper, news, digital content, downloadable video, streaming video, audio, a service, and a company.

26. The method of claim 21, wherein the plurality of recently viewed assets are from a plurality of web sites associated with a common entity.

27. The method of claim 21, wherein the one or more asset recommendations are transmitted to the user device for display on one or more of a home page, a door, a blog, a product page, a product listings page, a news article, an asset landing page, a search results page, a profile page, and an email.

28. A system for providing recommendations to a user based on user activity in a distributed network environment, the system comprising:
one or more processors; and
one or more memories operatively coupled to at least one of the one or more processors and having instructions stored thereon that, when executed by at least one of the one or more processors, cause at least one of the one or more processors to:
receive multiple sets of user page view information from multiple distributed computing devices connected to the distributed network environment, each set of page view information including an identification of the user viewing a page and an identification of the page viewed by the user;
store sets of user page information for each user in association with that user;
in response to a request from a user device for information from a distributed computing device, the information relating to an asset, determine a set of recently viewed assets based on one of the sets of user page information corresponding to the user
determine a set of neighbor assets associated with the recently viewed assets, wherein each neighbor asset is an asset which is associated with a corresponding recently viewed asset;
generate a plurality of subsets from the set recently viewed assets, wherein each subset in the plurality of subsets includes a plurality of recently viewed assets and has a corresponding neighbor subset comprising a plurality of neighbor assets associated with the plurality of recently viewed assets in the subset;
determine a score for each subset in the plurality of subsets to generate a plurality of scores, wherein the score for each subset is based on a strength of the association between the plurality of recently viewed assets in that subset and the plurality of neighbor assets in the corresponding neighbor subset;
determine the subset with the highest score;
generate by at least one of the one or more recommending computing devices one or more asset recommendations from the plurality of neighbor assets in the corresponding neighbor subset of the subset with the highest score; and
transmit the one or more asset recommendations to the user device.

29. The system of claim 28, wherein generating a plurality of subsets includes excluding duplicate recently viewed assets in each subset.

30. The system of claim 28, wherein determining a score for each subset comprises:
calculating a similarity measure between each recently viewed asset in the subset and each of the plurality of neighbor assets in the neighbor subset associated with that subset to generate one or more similarity scores; and
summing the one or more similarity scores to generate the score for the subset.

31. The system of claim 30, wherein the similarity measure comprises at least one of symmetric uncertainty and co-occurrence of the recently viewed asset with the neighbor asset among user sessions.

32. The system of claim 28, wherein the plurality of recently viewed assets comprise at least one of a product, a blog post, a user comment, a review, an article, a whitepaper, news, digital content, downloadable video, streaming video, audio, a service, and a company.

33. The system of claim 28, wherein the plurality of recently viewed assets are from a plurality of web sites associated with a common entity.

34. The system of claim 28, wherein the one or more asset recommendations are transmitted to the user device for display on one or more of a home page, a door, a blog, a product page, a product listings page, a news article, an asset landing page, a search results page, a profile page, and an email.

35. At least one non-transitory computer-readable medium storing computer-readable instructions that, when executed by one or more computing devices, cause at least one of the one or more computing devices to:
receive multiple sets of user page view information from multiple distributed computing devices connected to the distributed network environment, each set of page view information including an identification of the user viewing a page and an identification of the page viewed by the user;
store sets of user page information for each user in association with that user;
in response to a request from a user device for information from a distributed computing device, the information relating to an asset, determine a set of recently viewed assets based on one of the sets of user page information corresponding to the user
determine a set of neighbor assets associated with the recently viewed assets, wherein each neighbor asset is an asset which is associated with a corresponding recently viewed asset;
generate a plurality of subsets from the set recently viewed assets, wherein each subset in the plurality of subsets includes a plurality of recently viewed assets and has a corresponding neighbor subset comprising a plurality of neighbor assets associated with the plurality of recently viewed assets in the subset;
determine a score for each subset in the plurality of subsets to generate a plurality of scores, wherein the score for each subset is based on a strength of the association between the plurality of recently viewed assets in that subset and the plurality of neighbor assets in the corresponding neighbor subset;
determine the subset with the highest score;
generate by at least one of the one or more recommending computing devices one or more asset recommendations from the plurality of neighbor assets in the corresponding neighbor subset of the subset with the highest score; and
transmit the one or more asset recommendations to the user device.

36. The at least one non-transitory computer-readable medium of claim 35, wherein the instructions that, when executed by at least one of the one or more computing devices, cause at least one of the one or more computing devices to generate a plurality of subsets further cause at least one of the one or more computing devices to discount repeat recently viewed assets in each subset.

37. The at least one non-transitory computer-readable medium of claim 35, wherein the plurality of recently viewed assets comprise at least one of a product, a blog post, a user comment, a review, an article, a whitepaper, news, digital content, downloadable video, streaming video, audio, a service, and a company.

38. The at least one non-transitory computer-readable medium of claim 35, wherein the one or more asset recommendations are transmitted to the user on one or more of a home page, a door, a blog, a product page, a product listings page, a news article, an asset landing page, a search results page, a profile page, and an email.
